(19) United States
(12) Patent Application Publication
(10) Pub. No.: US 2026/0099998 A1
(43) Pub. Date: Apr. 9, 2026

(54) LEARNABLE GLOBAL BASES FOR GENERATING THREE-DIMENSIONAL REPRESENTATIONS FROM SINGLE-VIEW DATA COLLECTIONS

(71) Applicant: NVIDIA CORPORATION, Santa Clara, CA (US)

(72) Inventors: Koki NAGANO, Playa Vista, CA (US); Kaiwen JIANG, La Jolla, CA (US); Shalini DE MELLO, San Francisco, CA (US)

(21) Appl. No.: 19/351,193

(22) Filed: Oct. 6, 2025

Related U.S. Application Data
(60) Provisional application No. 63/704,969, filed on Oct. 8, 2024.

(51) Int. Cl. G06T 17/00; G06T 15/08

(52) U.S. Cl. CPC G06T 17/00; G06T 15/08; G06T 2210/56

(57) ABSTRACT

Generating a three-dimensional representation from a single-view includes receiving a single-view image, generating a plurality of coefficients, generating a 3D representation from a plurality of basis elements and the plurality of coefficients, processing the 3D representation and the single-view image to generate a plurality of optimized coefficients, generating an optimized 3D representation from the plurality of coefficients and the plurality of optimized basis elements, and rendering the optimized 3D representation to generate a volume rendering, and reconstructing a 3D scene from the volume rendering.

### CROSS-REFERENCE TO RELATED APPLICATIONS

This application claims priority benefit of the U.S. Provisional Patent Application titled, “LEARNABLE GLOBAL BASES FOR LEARNING THREE-DIMENSIONAL REPRESENTATIONS FROM SINGLE-VIEW DATA COLLECTIONS,” filed on Oct. 8, 2024, and having Ser. No. 63/704,969. The subject matter of this related application is hereby incorporated herein by reference.

### BACKGROUND OF THE INVENTION

### Field of the Invention

Embodiments of the present disclosure relate generally to autonomous vehicle technology, three-dimensional mapping, environmental modeling, and artificial intelligence and, more specifically, to learnable global bases for generating a three-dimensional representation from single-view data collections.

### Description of the Related Art

Three-dimensional (3D) scene reconstruction is the task of generating an accurate 3D representation of a scene from a set of two-dimensional (2D) images of the scene. 3D scene reconstruction has numerous applications in a wide variety of fields, including computer graphics, animation, and autonomous vehicle mapping and navigation.

A generative adversarial network (GAN) is a type of artificial neural network model capable of generating high-resolution, photorealistic 2D images which are nearly indistinguishable from real photographs. A GAN simultaneously trains two neural network models, a generative network and a discriminative network, through an adversarial process. The generative network generates images which are very similar to the input dataset and the discriminative network estimates the probability that a sample came from the input dataset rather than from the generative model. The GAN trains the generative network to maximize the probability that the discriminative network is being fooled by the generated images and cannot tell whether an image is from the input dataset or generated. For 3D scene generation, 3D GANs train from a collection of single-view 2D images, but use a 3D representation, such as neural field representation or feature grid representation, and differentiable rendering, such as neural volume rendering, in the generative network to learn the 3D scene.

One drawback of the 3D GAN approach, however, is that training a 3D GAN is unstable. 3D GANs are prone to mode collapse, where the generative network does not capture the diversity of the data distribution and produces a limited variety of samples. In addition, 3D GANs are limited to object scale scenes and are difficult to scale to a large-scale data set. As the complexity of the data increases, training a 3D GAN becomes more unstable.

A diffusion model is another type of machine learning model used for image generation. Diffusion models are trained in two steps, the forward diffusion process and the reverse sampling process. The forward diffusion process generates a sequence of noisy images by iteratively adding Gaussian noise to a training image. During the reverse sampling process, the diffusion model learns to de-noise the noisy images generated during the forward process. After training, diffusion models can generate new images with a similar distribution as the training images.

One drawback of using diffusion models for 3D scene reconstruction is that diffusion models are typically trained using reconstruction loss functions. Reconstruction loss functions require multi-view images for accurate 3D scene reconstruction. However, there is a shortage of high-quality multi-view datasets. The lack of high-quality multi-view datasets needed for multi-view consistency and shape quality limits the performance of diffusion models for 3D scene reconstruction.

Another drawback of current 3D scene reconstruction techniques is the lack of compact 3D representation, which is ideal for streaming applications. There are significant computational and memory costs in using raw 3D representations, such as triplanes or voxels, of a 2D image. Using raw 3D representations to train a 3D generative model is slow and computationally inefficient. Training a 3D generative model typically requires rendering tens of millions of images and neural volume rendering of many images from a raw 3D representation at a high resolution is computationally expensive.

As the foregoing illustrates, what is needed in the art are more effective techniques for reconstructing 3D scenes.

### SUMMARY

According to some embodiments, a computer-implemented method for reconstructing 3D scenes. The method includes receiving a single-view image, generating a plurality of coefficients, generating a 3D representation from a plurality of basis elements and the plurality of coefficients, processing the 3D representation and the single-view image to update the plurality basis elements to generate a plurality of optimized basis elements, generating an optimized 3D representation from the plurality of optimized basis elements and the plurality of coefficients, rendering the optimized 3D representation to generate a volume rendering, and reconstructing a 3D scene from the volume rendering.

Further embodiments provide, among other things, non-transitory computer-readable storage media storing instructions and systems configured to implement the method set forth above.

At least one technical advantage of the disclosed techniques relative to the prior art is that, with the disclosed techniques, accurate reconstruction of 3D scenes can be generated from a single-view image. The disclosed technique can generate accurate reconstruction of 3D scenes that are consistent across multiple views and yields consistent 3D shapes from one single-view image, eliminating the need for large labeled multi-view datasets to generate the reconstructed 3D scene. In addition, with the disclosed techniques accurate reconstruction of 3D scenes can be generated without having to train specialized neural models, which significantly reduces the computing resources used to generate the reconstructed 3D scene. These technical advantages represent one or more technological improvements over prior art approaches.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a block diagram of a computer system configured to implement one or more aspects of the present disclosure;

FIG. 2 is a block diagram of a parallel processing unit included in the parallel processing subsystem of FIG. 1, according to various embodiments;

FIG. 3 is a block diagram of a general processing cluster included in the parallel processing unit of FIG. 2, according to various embodiments;

FIG. 4 is a block diagram of a computer-based system configured to implement one or more aspects of the various embodiments;

FIG. 5 is a more detailed description of the 3D scene reconstruction engine of FIG. 4, according to various embodiments;

FIG. 6 is a more detailed illustration of an example of the coefficient generator of FIG. 5, according to various embodiments;

FIG. 7 is a more detailed illustration of the 3D representation generator of FIG. 5, according to various embodiments;

FIG. 8 is a more detailed illustration of the global basis optimizer of FIG. 4, according to various embodiments;

FIG. 9 is a flow diagram of method steps for generating optimized global bases, according to various embodiments;

FIG. 10 is a flow diagram of method steps for generating optimized global bases, according to various embodiments; and

FIG. 11 is a flow diagram of method steps for generating a reconstructed 3D scene, according to various embodiments.

### DETAILED DESCRIPTION

In the following description, numerous specific details are set forth to provide a more thorough understanding of the present invention. However, it will be apparent to one of skill in the art that the present invention may be practiced without one or more of these specific details.

Embodiments of the present disclosure provide techniques for reconstruction of a 3D scene from a single-view image. First, a global basis representation, such as triplanes or voxels is chosen. Then a set of coefficients is generated 1) using a vision transformer, or 2) by using a neural network and Monte Carlo integration. When using the vision transformer, a single-view image is input into a vision transformer, and the output of the vision transformer is a set of coefficients. Then a 3D representation is obtained as a linear combination of the coefficients and upsampled global bases elements. The 3D representations are rendered using a volume rendering technique. The global bases elements are optimized, and the vision transformer is trained by minimizing the batch reconstruction loss between the rendered 3D representations and the originally observed single-view images. When using the neural network and Monte Carlo integration, the neural network generates a partial observation map, a depth map, and a probability distribution map. Next, a dense set of 3D points is obtained by sampling the depth map. Then, coefficients are generated using Monte Carlo integration evaluated at the sampled 3D points. A 3D representation is generated as a linear combination of the coefficients and upsampled global bases elements. The 3D representation is rendered using a volume rendering technique. The global bases elements are optimized, and the neural network is trained by jointly minimizing the batch reconstruction loss between the rendered 3D representations and the partial observation map and the rendered 3D representations and the originally observed single view images. Whether generated by either method, an optimized 3D representation is obtained as a linear combination of the coefficients and the optimized global bases elements. The optimized 3D representation is then rendered using a volume rendering technique to reconstruct a 3D scene that closely matches the originally observed single-view image.

The techniques for performing learnable global bases for generating a three-dimensional representation from single-view data collections have many real world applications. For example, these techniques can be used in systems where 3D scenes are reconstructed using 2D images, such as vehicle navigation systems, and/or the like. These techniques also have applications in virtual and augmented reality, as well as medical imaging.

The above examples are not in any way intended to be limiting. As persons skilled in the art will appreciate, as a general matter, the techniques of using global bases for generating a three-dimensional representation from single-view data collections that are described herein can be implemented in any application where 3D reconstruction of scenes using single-view images is required or useful.

### System Overview

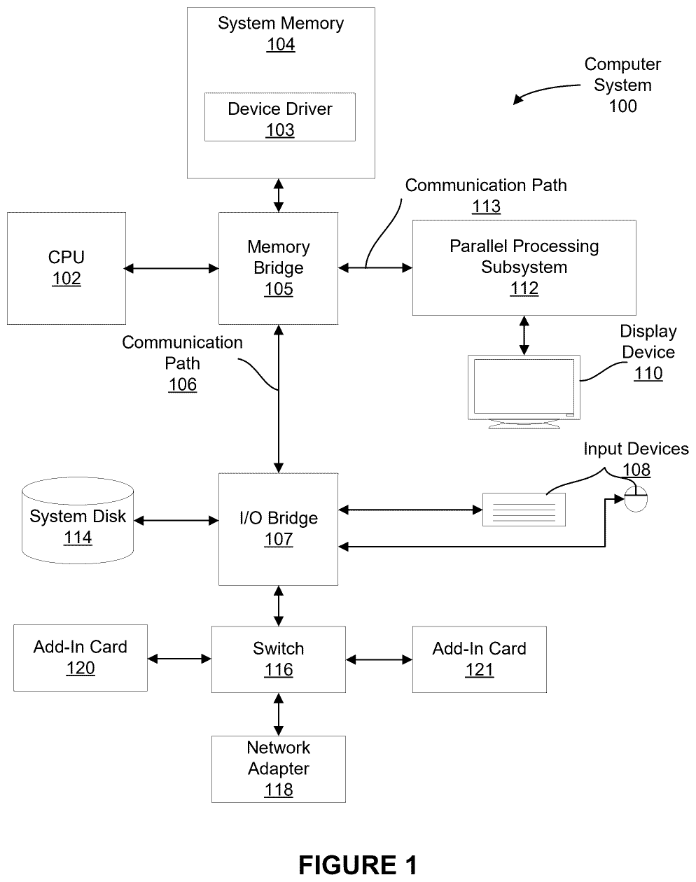

FIG. 1 is a block diagram of a computer system 100 configured to implement one or more aspects of the present disclosure. As shown, computer system 100 includes, without limitation, a central processing unit (CPU) 102 and a system memory 104 coupled to a parallel processing subsystem 112 via a memory bridge 105 and a communication path 113. Memory bridge 105 is further coupled to an I/O (input/output) bridge 107 via a communication path 106, and I/O bridge 107 is, in turn, coupled to a switch 116. As persons skilled in the art will appreciate, computer system 100 can be any type of technically feasible computer system, including, without limitation, a server machine, a server platform, a desktop machine, laptop machine, or a hand-held/mobile device. Persons skilled in the art also will appreciate that computer system 100 or systems similar to computer system 100 can be incorporated into a vehicle or machine to facilitate driving, steering, or otherwise controlling that vehicle or machine, as the case may be.

In operation, I/O bridge 107 is configured to receive user input information from input devices 108, such as a keyboard or a mouse, and forward the input information to CPU 102 for processing via communication path 106 and memory bridge 105. Switch 116 is configured to provide connections between I/O bridge 107 and other components of the computer system 100, such as a network adapter 118 and various add-in cards 120 and 121.

As also shown, I/O bridge 107 is coupled to a system disk 114 that may be configured to store content and applications and data for use by CPU 102 and parallel processing subsystem 112. As a general matter, system disk 114 provides non-volatile storage for applications and data and may include fixed or removable hard disk drives, flash memory devices, and CD-ROM (compact disc read-only-memory), DVD-ROM (digital versatile disc-ROM), Blu-ray, HD-DVD (high definition DVD), or other magnetic, optical, or solid state storage devices. Finally, although not explicitly shown, other components, such as universal serial bus or other port connections, compact disc drives, digital versatile disc drives, film recording devices, and the like, may be connected to I/O bridge 107 as well.

In various embodiments, memory bridge 105 may be a Northbridge chip, and I/O bridge 107 may be a Southbrige chip. In addition, communication paths 106 and 113, as well as other communication paths within computer system 100, may be implemented using any technically suitable protocols, including, without limitation, AGP (Accelerated Graphics Port), HyperTransport, or any other bus or point-to-point communication protocol known in the art.

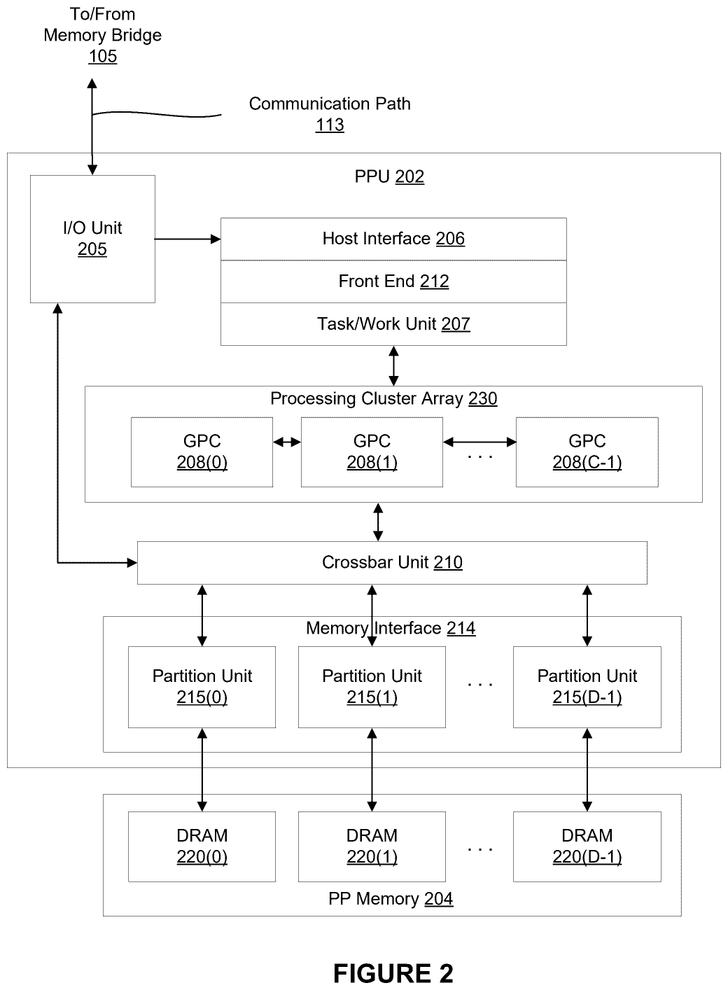

In some embodiments, parallel processing subsystem 112 comprises a graphics subsystem that delivers pixels to a display device 110 that may be any conventional cathode ray tube, liquid crystal display, light-emitting diode display, or the like. In such embodiments, the parallel processing subsystem 112 incorporates circuitry optimized for graphics and video processing, including, for example, video output circuitry. As described in greater detail below in FIG. 2, such circuitry may be incorporated across one or more parallel processing units (PPUs) included within parallel processing subsystem 112. In other embodiments, the parallel processing subsystem 112 incorporates circuitry optimized for general purpose and/or compute processing. Again, such circuitry may be incorporated across one or more PPUs included within parallel processing subsystem 112 that are configured to perform such general purpose and/or compute operations. In yet other embodiments, the one or more PPUs included within parallel processing subsystem 112 may be configured to perform graphics processing, general purpose processing, and compute processing operations. System memory 104 includes at least one device driver 103 configured to manage the processing operations of the one or more PPUs within parallel processing subsystem 112.

In various embodiments, parallel processing subsystem 112 may be integrated with one or more other the other elements of FIG. 1 to form a single system. For example, parallel processing subsystem 112 may be integrated with CPU 102 and other connection circuitry on a single chip to form a system on chip (SoC).

It will be appreciated that the system shown herein is illustrative and that variations and modifications are possible. The connection topology, including the number and arrangement of bridges, the number of CPUs 102, and the number of parallel processing subsystems 112, may be modified as desired. For example, in some embodiments, system memory 104 could be connected to CPU 102 directly rather than through memory bridge 105, and other devices would communicate with system memory 104 via memory bridge 105 and CPU 102. In other alternative topologies, parallel processing subsystem 112 may be connected to I/O bridge 107 or directly to CPU 102, rather than to memory bridge 105. In still other embodiments, I/O bridge 107 and memory bridge 105 may be integrated into a single chip instead of existing as one or more discrete devices. Lastly, in certain embodiments, one or more components shown in FIG. 1 may not be present. For example, switch 116 could be eliminated, and network adapter 118 and add-in cards 120, 121 would connect directly to I/O bridge 107.

FIG. 2 is a block diagram of a parallel processing unit (PPU) 202 included in the parallel processing subsystem 112 of FIG. 1, according to various embodiments. Although FIG. 2 depicts one PPU 202, as indicated above, parallel processing subsystem 112 may include any number of PPUs 202. As shown, PPU 202 is coupled to a local parallel processing (PP) memory 204. PPU 202 and PP memory 204 may be implemented using one or more integrated circuit devices, such as programmable processors, application specific integrated circuits (ASICs), or memory devices, or in any other technically feasible fashion.

In some embodiments, PPU 202 comprises a graphics processing unit (GPU) that may be configured to implement a graphics rendering pipeline to perform various operations related to generating pixel data based on graphics data supplied by CPU 102 and/or system memory 104. When processing graphics data, PP memory 204 can be used as graphics memory that stores one or more conventional frame buffers and, if needed, one or more other render targets as well. Among other things, PP memory 204 may be used to store and update pixel data and deliver final pixel data or display frames to display device 110 for display. In some embodiments, PPU 202 also may be configured for general-purpose processing and compute operations.

In operation, CPU 102 is the master processor of computer system 100, controlling and coordinating operations of other system components. In particular, CPU 102 issues commands that control the operation of PPU 202. In some embodiments, CPU 102 writes a stream of commands for PPU 202 to a data structure (not explicitly shown in either FIG. 1 or FIG. 2) that may be located in system memory 104, PP memory 204, or another storage location accessible to both CPU 102 and PPU 202. A pointer to the data structure is written to a pushbuffer to initiate processing of the stream of commands in the data structure. The PPU 202 reads command streams from the pushbuffer and then executes commands asynchronously relative to the operation of CPU 102. In embodiments where multiple pushbuffers are generated, execution priorities may be specified for each pushbuffer by an application program via device driver 103 to control scheduling of the different pushbuffers.

As also shown, PPU 202 includes an I/O (input/output) unit 205 that communicates with the rest of computer system 100 via the communication path 113 and memory bridge 105. I/O unit 205 generates packets (or other signals) for transmission on communication path 113 and also receives all incoming packets (or other signals) from communication path 113, directing the incoming packets to appropriate components of PPU 202. For example, commands related to processing tasks may be directed to a host interface 206, while commands related to memory operations (e.g., reading from or writing to PP memory 204) may be directed to a crossbar unit 210. Host interface 206 reads each pushbuffer and transmits the command stream stored in the pushbuffer to a front end 212.

As mentioned above in conjunction with FIG. 1, the connection of PPU 202 to the rest of computer system 100 may be varied. In some embodiments, parallel processing subsystem 112, which includes at least one PPU 202, is implemented as an add-in card that can be inserted into an expansion slot of computer system 100. In other embodiments, PPU 202 can be integrated on a single chip with a bus bridge, such as memory bridge 105 or I/O bridge 107. Again, in still other embodiments, some or all of the elements of PPU 202 may be included along with CPU 102 in a single integrated circuit or system of chip (SoC).

In operation, front end 212 transmits processing tasks received from host interface 206 to a work distribution unit (not shown) within task/work unit 207. The work distribution unit receives pointers to processing tasks that are encoded as task metadata (TMD) and stored in memory. The pointers to TMDs are included in a command stream that is stored as a pushbuffer and received by the front end 212 from the host interface 206. Processing tasks that may be encoded as TMDs include indices associated with the data to be processed as well as state parameters and commands that define how the data is to be processed. For example, the state parameters and commands could define the program to be executed on the data. The task/work unit 207 receives tasks from the front end 212 and ensures that GPCs 208 are configured to a valid state before the processing task specified by each one of the TMDs is initiated. A priority may be specified for each TMD that is used to schedule the execution of the processing task. Processing tasks also may be received from the processing cluster array 230. Optionally, the TMD may include a parameter that controls whether the TMD is added to the head or the tail of a list of processing tasks (or to a list of pointers to the processing tasks), thereby providing another level of control over execution priority.

PPU 202 advantageously implements a highly parallel processing architecture based on a processing cluster array 230 that includes a set of C general processing clusters (GPCs) 208, where C 1. Each GPC 208 is capable of executing a large number (e.g., hundreds or thousands) of threads concurrently, where each thread is an instance of a program. In various applications, different GPCs 208 may be allocated for processing different types of programs or for performing different types of computations. The allocation of GPCs 208 may vary depending on the workload arising for each type of program or computation.

Memory interface 214 includes a set of D of partition units 215, where D 1. Each partition unit 215 is coupled to one or more dynamic random access memories (DRAMs) 220 residing within PPM memory 204. In one embodiment, the number of partition units 215 equals the number of DRAMs 220, and each partition unit 215 is coupled to a different DRAM 220. In other embodiments, the number of partition units 215 may be different than the number of DRAMs 220. Persons of ordinary skill in the art will appreciate that a DRAM 220 may be replaced with any other technically suitable storage device. In operation, various render targets, such as texture maps and frame buffers, may be stored across DRAMs 220, allowing partition units 215 to write portions of each render target in parallel to efficiently use the available bandwidth of PP memory 204.

A given GPCs 208 may process data to be written to any of the DRAMs 220 within PP memory 204. Crossbar unit 210 is configured to route the output of each GPC 208 to the input of any partition unit 215 or to any other GPC 208 for further processing. GPCs 208 communicate with memory interface 214 via crossbar unit 210 to read from or write to various DRAMs 220. In one embodiment, crossbar unit 210 has a connection to I/O unit 205, in addition to a connection to PP memory 204 via memory interface 214, thereby enabling the processing cores within the different GPCs 208 to communicate with system memory 104 or other memory not local to PPU 202. In the embodiment of FIG. 2, crossbar unit 210 is directly connected with I/O unit 205. In various embodiments, crossbar unit 210 may use virtual channels to separate traffic streams between the GPCs 208 and partition units 215.

Again, GPCs 208 can be programmed to execute processing tasks relating to a wide variety of applications, including, without limitation, linear and nonlinear data transforms, filtering of video and/or audio data, modeling operations (e.g., applying laws of physics to determine position, velocity and other attributes of objects), image rendering operations (e.g., tessellation shader, vertex shader, geometry shader, and/or pixel/fragment shader programs), general compute operations, etc. In operation, PPU 202 is configured to transfer data from system memory 104 and/or PP memory 204 to one or more on-chip memory units, process the data, and write result data back to system memory 104 and/or PP memory 204. The result data may then be accessed by other system components, including CPU 102, another PPU 202 within parallel processing subsystem 112, or another parallel processing subsystem 112 within computer system 100.

As noted above, any number of PPUs 202 may be included in a parallel processing subsystem 112. For example, multiple PPUs 202 may be provided on a single add-in card, or multiple add-in cards may be connected to communication path 113, or one or more of PPUs 202 may be integrated into a bridge chip. PPUs 202 in a multi-PPU system may be identical to or different from one another. For example, different PPUs 202 might have different numbers of processing cores and/or different amounts of PP memory 204. In implementations where multiple PPUs 202 are present, those PPUs may be operated in parallel to process data at a higher throughput than is possible with a single PPU 202. Systems incorporating one or more PPUs 202 may be implemented in a variety of configurations and form factors, including, without limitation, desktops, laptops, handheld personal computers or other handheld devices, servers, workstations, game consoles, embedded systems, and the like.

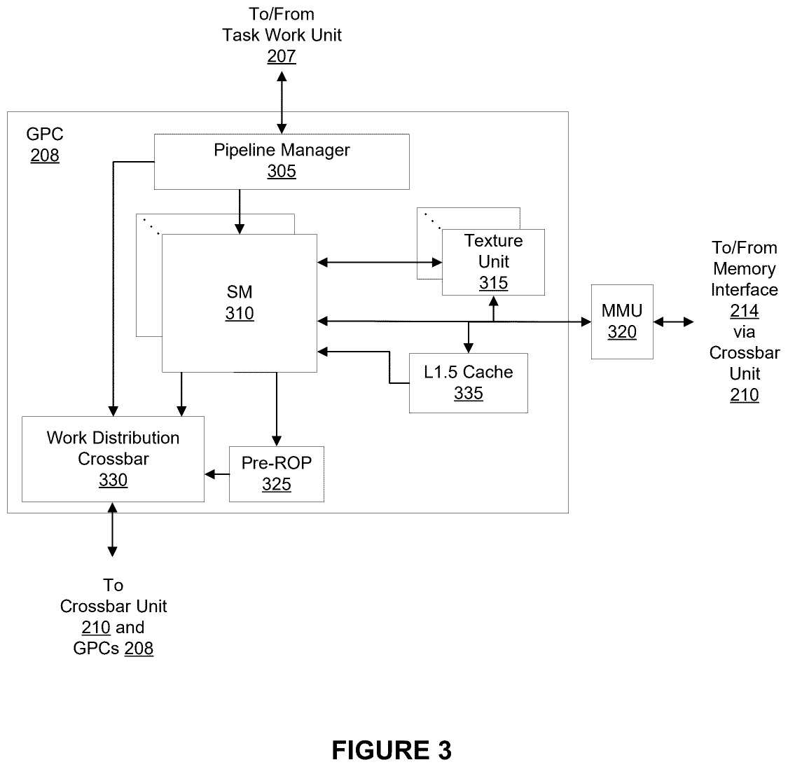

FIG. 3 is a block diagram of a GPC 208 included in PPU 202 of FIG. 2, according to various embodiments. In operation, GPC 208 may be configured to execute a large number of threads in parallel to perform graphics, general processing and/or compute operations. As used herein, a “thread” refers to an instance of a particular program executing on a particular set of input data. In some embodiments, single-instruction, multiple-data (SIMD) instruction issue techniques are used to support parallel execution of a large number of threads without providing multiple independent instruction units. In other embodiments, single-instruction, multiple-thread (SIMT) techniques are used to support parallel execution of a large number of generally synchronized threads, using a common instruction unit configured to issue instructions to a set of processing engines within GPC 208. Unlike a SIMD execution regime, where all processing engines typically execute identical instructions, SIMT execution allows different threads to more readily follow divergent execution paths through a given program. Persons of ordinary skill in the art will understand that a SIMD processing regime represents a functional subset of a SIMT processing regime.

Operation of GPC 208 is controlled via a pipeline manager 305 that distributes processing tasks received from a work distribution unit (not shown) within task/work unit 207 to one or more streaming multiprocessors (SMs) 310. Pipeline manager 305 may also be configured to control a work distribution crossbar 330 by specifying destinations for processed data output by SMs 310.

In one embodiment, GPC 208 includes a set of M of SMs 310, where M≥1. Also, each SM 310 includes a set of functional execution units (not shown), such as execution units and load-store units. Processing operations specific to any of the functional execution units may be pipelined, which enables a new instruction to be issued for execution before a previous instruction has completed execution. Any combination of functional execution units within a given SM 310 may be provided. In various embodiments, the functional execution units may be configured to support a variety of different operations including integer and floating point arithmetic (e.g., addition and multiplication), comparison operations, Boolean operations (AND, OR, XOR), bit-shifting, and computation of various algebraic functions (e.g., planar interpolation and trigonometric, exponential, and logarithmic functions, etc.). Advantageously, the same functional execution unit can be configured to perform different operations.

In operation, each SM 310 is configured to process one or more thread groups. As used herein, a “thread group” or “warp” refers to a group of threads concurrently executing the same program on different input data, with one thread of the group being assigned to a different execution unit within an SM 310. A thread group may include fewer threads than the number of execution units within the SM 310, in which case some of the execution may be idle during cycles when that thread group is being processed. A thread group may also include more threads than the number of execution units within the SM 310, in which case processing may occur over consecutive clock cycles. Since each SM 310 can support up to G thread groups concurrently, it follows that up to G*M thread groups can be executing in GPC 208 at any given time.

Additionally, a plurality of related thread groups may be active (in different phases of execution) at the same time within an SM 310. This collection of thread groups is referred to herein as a “cooperative thread array” (“CTA”) or “thread array.” The size of a particular CTA is equal to m*k, where k is the number of concurrently executing threads in a thread group, which is typically an integer multiple of the number of execution units within the SM 310, and m is the number of thread groups simultaneously active within the SM 310.

Although not shown in FIG. 3, each SM 310 contains a level one (L1) cache or uses space in a corresponding L1 cache outside of the SM 310 to support, among other things, load and store operations performed by the execution units. Each SM 310 also has access to level two (L2) caches (not shown) that are shared among all GPCs 208 in PPU 202. The L2 caches may be used to transfer data between threads. Finally, SMs 310 also have access to off-chip “global” memory, which may include PP memory 204 and/or system memory 104. It is to be understood that any memory external to PPU 202 may be used as global memory. Additionally, as shown in FIG. 3, a level one-point-five (L1.5) cache 335 may be included within GPC 208 and configured to receive and hold data requested from memory via memory interface 214 by SM 310. Such data may include, without limitation, instructions, uniform data, and constant data. In embodiments having multiple SMs 310 within GPC 208, the SMs 310 may beneficially share common instructions and data cached in L1.5 cache 335.

Each GPC 208 may have an associated memory management unit (MMU) 320 that is configured to map virtual addresses into physical addresses. In various embodiments, MMU 320 may reside either within GPC 208 or within the memory interface 214. The MMU 320 includes a set of page table entries (PTEs) used to map a virtual address to a physical address of a tile or memory page and optionally a cache line index. The MMU 320 may include address translation lookaside buffers (TLB) or caches that may reside within SMs 310, within one or more L1 caches, or within GPC 208.

In graphics and compute applications, GPC 208 may be configured such that each SM 310 is coupled to a texture unit 315 for performing texture mapping operations, such as determining texture sample positions, reading texture data, and filtering texture data.

In operation, each SM 310 transmits a processed task to work distribution crossbar 330 in order to provide the processed task to another GPC 208 for further processing or to store the processed task in an L2 cache (not shown), parallel processing memory 204, or system memory 104 via crossbar unit 210. In addition, a pre-raster operations (preROP) unit 325 is configured to receive data from SM 310, direct data to one or more raster operations (ROP) units within partition units 215, perform optimizations for color blending, organize pixel color data, and perform address translations.

It will be appreciated that the core architecture described herein is illustrative and that variations and modifications are possible. Among other things, any number of processing units, such as SMs 310, texture units 315, or preROP units 325, may be included within GPC 208. Further, as described above in conjunction with FIG. 2, PPU 202 may include any number of GPCs 208 that are configured to be functionally similar to one another so that execution behavior does not depend on which GPC 208 receives a particular processing task. Further, each GPC 208 operates independently of the other GPCs 208 in PPU 202 to execute tasks for one or more application programs. In view of the foregoing, persons of ordinary skill in the art will appreciate that the architecture described in FIGS. 1-3 in no way limits the scope of the present invention.

### Reconstructed 3D Scene Generation

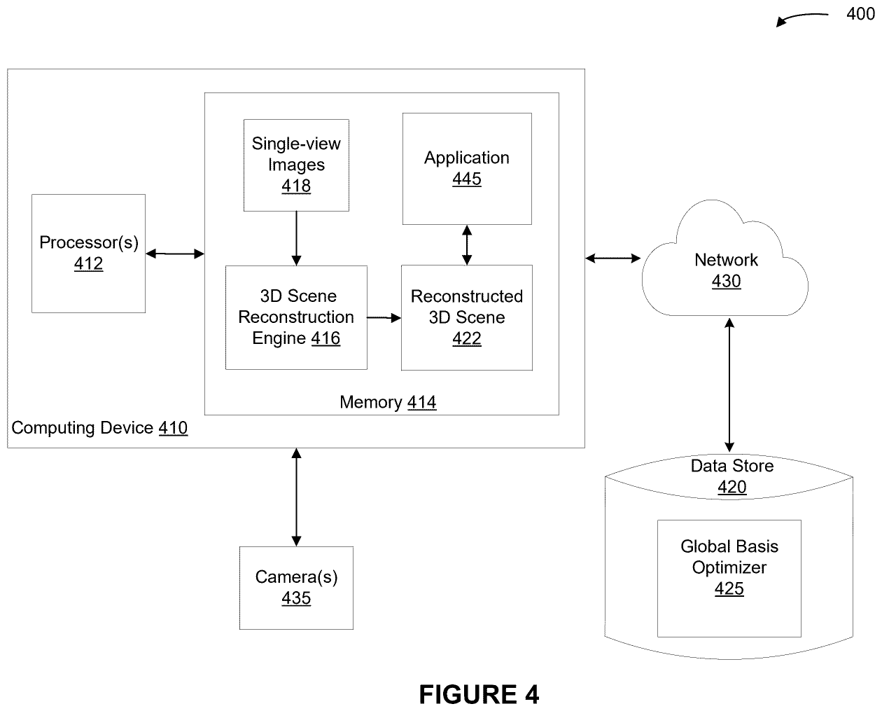

FIG. 4 illustrates a block diagram of a computer-based system 400 configured to implement one or more aspects of the various embodiments. As shown, computer-based system 400 includes, without limitation, a computing device 410, a data store 420, a network 430, and camera(s) 435. Computing device 410 includes, without limitation, processor(s) 412 and a memory 414. Memory 414 includes, without limitation, a 3D scene reconstruction engine 416, single-view images 418, reconstructed 3D scene 422, and application 445. Data store 420 stores, without limitation, a global basis optimizer 425. Computing device 410 can include similar components, features, and/or functionality as the exemplary computer system 100, described above in conjunction with FIG. 1-3. Computing device 410 can be any technically feasible type of computer system, including, without limitation, a server machine or a server platform.

Computing device 410 shown herein is for illustrative purposes only, and variations and modifications are possible without departing from the scope of the present disclosure. For example, the number and types of processors 412, the number of GPUs and/or other processing unit types, the number and types of system memories 414, and/or the number of applications included in the memory 414 can be modified as desired. Further, the connection topology between the various units within computing device 410 can be modified as desired. In some embodiments, any combination of the processor(s) 412 and the memory 414, and/or GPU(s) can be included in and/or replaced with any type of virtual computing system, distributed computing system, and/or cloud computing environment, such as a public, private, or a hybrid cloud system.

Processor(s) 412 receive user input from input devices, such as a keyboard or a mouse. Processor(s) 412 can be any technically feasible form of processing device configured to process data and execute program code. For example, any of processor(s) 412 could be a central processing unit (CPU), a graphics processing unit (GPU), an application-specific integrated circuit (ASIC), a field-programmable gate array (FPGA), and so forth. In various embodiments any of the operations and/or functions described herein can be performed by processor(s) 412, or any combination of these different processors, such as a CPU working in cooperation with one or more GPUs. In various embodiments, the processor(s) 412 can issue commands that control the operation of one or more GPUs (not shown) and/or other parallel processing circuitry (e.g., parallel processing units, deep learning accelerators, etc.) that incorporates circuitry optimized for graphics and video processing, including, for example, video output circuitry. The GPU(s) can deliver pixels to a display device that can be any conventional cathode ray tube, liquid crystal display, light-emitting diode display, and/or the like.

Memory 414 of computing device 410 stores content, such as software applications and data, for use by processor(s) 412. Memory 414 can be any type of memory capable of storing data and software applications, such as a random-access memory (RAM), a read-only memory (ROM), an erasable programmable read-only memory (EPROM or Flash ROM), or any suitable combination of the foregoing. In some embodiments, a storage (not shown) can supplement or replace memory 414. The storage can include any number and type of external memories that are accessible to processor(s) 412. For example, and without limitation, the storage can include a Secure Digital Card, an external Flash memory, a portable compact disc read-only memory (CD-ROM), an optical storage device, a magnetic storage device, and/or any suitable combination of the foregoing.

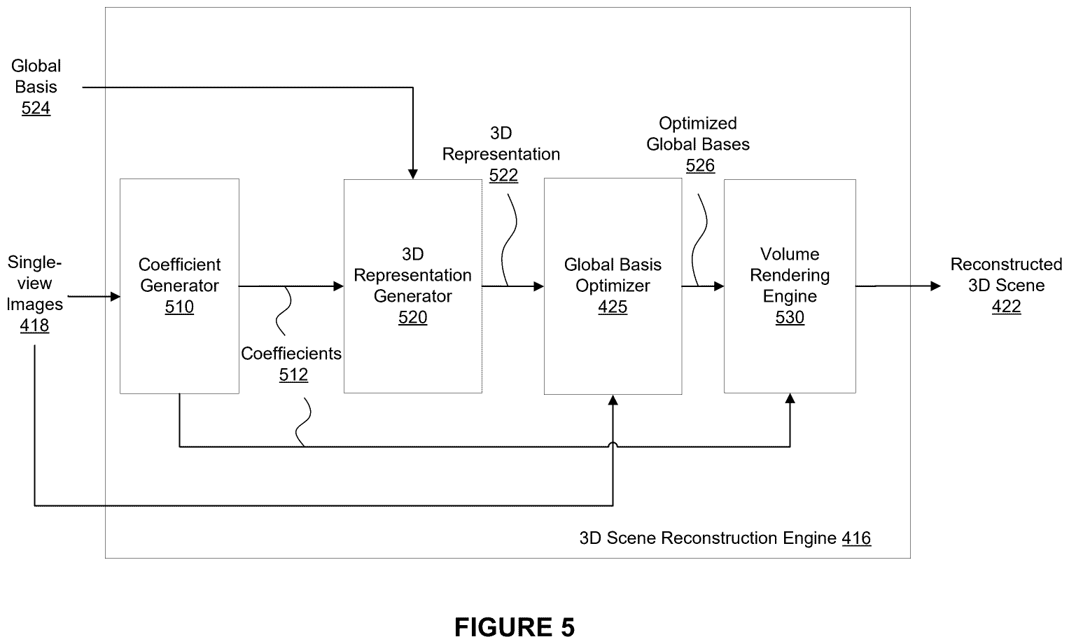

3D scene reconstruction engine 416 stored within memory 414 is configured to generate reconstructed 3D scene 422 using single-view images 418. First, a set of global bases, such as triplanes or voxels, is chosen. Then a set of coefficients is generated 1) using a vision transformer, or 2) by using a neural network and Monte Carlo integration. Whether generated by either method, an optimized 3D representation is obtained as a linear combination of the coefficients and optimized global bases elements. The optimized 3D representation is then rendered using a volume rendering technique to generate reconstructed 3D scene 422. Reconstructed 3D scene 422 can then be used in any suitable application, such as application 445 executing on computing device 410. The operations performed by 3D scene reconstruction engine 416 to generate reconstructed 3D scene 422 are described in greater detail below in conjunction with FIGS. 5-11.

Single-view image 418 is a single image obtained from one viewpoint of a scene. Single-view image 418 can be obtained by any type of technically feasible camera or video capture device such as camera(s) 435. For example, and without limitation, single-view image 418 can be obtained by a monocular camera such as a smartphone camera or a camera located in a vehicle. Single-view image 418 can be loaded by 3D scene reconstruction engine 416 from any one of camera(s) 435.

Application 445 accesses reconstructed 3D scene 422. Application 445 can be, without limitation, any type of navigation system, map, or route and direction assistant in an autonomous or manned vehicle and/or a hand-held device. For example, application 445 can load reconstructed 3D scene 422 and then use vehicle location and position information and reconstructed 3D scene 422 to render an image of the current location. In various embodiments, application 445 shows previews of a planned route, renders a view from specific coordinates, or annotates an image to displays landmarks or other points of interest.

Data store 420 provides non-volatile storage for applications and data in computing device 410. For example, and without limitation, training data, trained (or deployed) machine learning models and/or application data, global basis optimizer 425, single-view images 418, and reconstructed 3D scene 422 can be stored in the data store 420 for use by application 445. In some embodiments, data store 420 can include fixed or removable hard disk drives, flash memory devices, and CD-ROM (compact disc read-only-memory), DVD-ROM (digital versatile disc-ROM), Blu-ray, HD-DVD (high definition DVD), or other magnetic, optical, or solid state storage devices. Data store 420 can be a network attached storage (NAS) and/or a storage area-network (SAN). Although shown as coupled to computing device 410 via network 430, in various embodiments, computing device 410 can include data store 420.

Camera(s) 435 includes any technically feasible type of camera or video capture device. For example, and without limitation, camera(s) 435 can be a monocular camera such as a smartphone camera or a camera located in a vehicle. In various embodiments, camera(s) 435 sends single-view image 418 to computing device 410 to be loaded by 3D scene reconstruction engine 416.

Network 430 includes any technically feasible type of communications network that allows data to be exchanged between computing device 410, data store 420 and external entities or devices, such as a web server or another networked computing device. For example, network 430 can include a wide area network (WAN), a local area network (LAN), a cellular network, a wireless (WiFi) network, and/or the Internet, among others.

FIG. 5 is a more detailed illustration of 3D scene reconstruction engine 416 of FIG. 4, according to various embodiments. As shown, 3D scene reconstruction engine 416 includes, without limitation, a coefficient generator 510, a 3D representation generator 520, a global basis optimizer 425, and a volume rendering engine 530. Coefficient generator 510 receives single-view images 418 and generates coefficients 512. 3D representation generator receives coefficients 512 and global basis 524 and generates 3D representation 522. Global basis optimizer 425 receives 3D representation 522 and single-view images 418 and generates optimized global bases 526. Volume rendering engine receives optimized global bases 526 and coefficients 5122 and generates a rendering of reconstructed 3D scene 422. 3D scene reconstruction engine 416 receives single-view images 418 and global basis 524 and generates reconstructed 3D scene 422. In some embodiments, 3D scene reconstruction engine 416 receives single view images 418 and global basis 524 via one or more selections made by a user using a user interface (not shown). In various embodiments, global basis 524 can be a basis of triplanes, or a basis of voxels. In a basis of triplanes, the features of single-view image 418 are aligned along three axis aligned orthogonal feature planes. Then, any 3D position can be queried by projection onto each of the three feature planes. In a basis of voxels, single-view image 418 is divided into a grid of volume elements, known as voxels. Each voxel in the grid includes color and density information.

Coefficient generator 510 receives single-view images 418 and generates coefficients 512. In one embodiment, coefficient generator 510 is any type technically feasible transformer-based machine learning model. For example, in various embodiments, coefficient generator 510 can be a vision transformer with any suitable architecture. More generally, the input dataset to coefficient generator 510 can include any technically feasible data that can be processed by a transformer-based model for computer vision. Upon receiving single-view images 418, coefficient generator 510 passes single-view images 418 through multiple transformer blocks. Each transformer block of coefficient generator 510 can include multiple layers, including an attention layer, a multilayer perceptron (MLP) layer, and/or the like. Each transformer block has varying numbers of internal parameters including, without limitation, numbers of attention heads, key-value projection dimensions, numbers of neurons, types of activation functions, and/or the like. In various embodiments, each layer in transformer block of coefficient generator includes a layer norm layer, a linear layer, a convolutional layer, a pooling layer, a softmax layer, and/or any other type of viable artificial neural network layer. After passing single-view images 418 through the transformer blocks of coefficient generator 510, coefficient generator 510 generates coefficients 512.

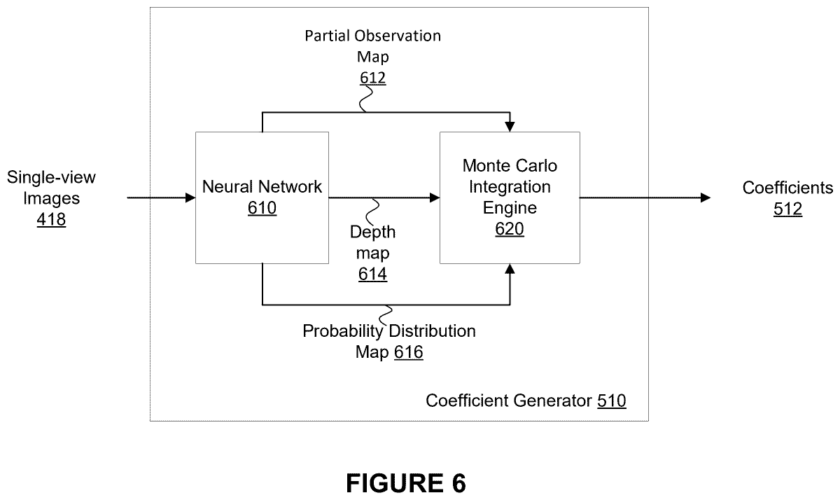

In another embodiment, coefficient generator 510 receives single-view images 418 and uses a neural network and Monte Carlo integration to generate coefficients 512. The operations of coefficient generator 510 are described in further detail below in conjunction with FIG. 6.

FIG. 6 is a more detailed illustration of another example of coefficient generator 510 of FIG. 5, according to various embodiments. As shown, coefficient generator 510 includes neural network 610 and Monte Carlo integration engine 620. Neural network 610 receives single-view images 418 and generates a partial observation map 612, a depth map 614, and a probability distribution map 616. Monte Carlo integration engine receives a partial observation map 612, a depth map 614, and a probability distribution map 616 and generates coefficients 512. Coefficient generator 510 receives single-view images 418 and generates coefficients 512.

Neural network 610 can be any type of technically feasible machine learning model. For example, in various embodiments, neural network 610 can be a U-Net with any suitable architecture. More generally, the input dataset to neural network 610 can include any technically feasible data that can be processed by a convolutional neural network (CNN) model. Upon receiving single-view images 418, neural network 610 passes single-view images 418 through multiple layers. Each layer of neural network 610 can include a convolutional layer, a pooling layer, a fully connected layer, a normalization layer, and/or any other type of viable artificial neural network layer. Each layer of neural network 610 has a varying number of internal parameters including, without limitation, numbers of neurons, types of activation function, and/or the like. After passing single-view images 418 through the layers of neural network 610, neural network 610 generates partial observation map 612, depth map 614, and probability distribution map 616. Partial observation map 612, F′, is a linear combination of global bases elements of global basis 524 and coefficients determined by neural network 610 according to equation (1):

$${F}^{′} = {c}_{1}^{′} {B}_{1} + {c}_{2}^{′} {B}_{2} + ⋯ + {c}_{n}^{′} {B}_{n} \qquad ( 1 )$$

where B₁, . . . , Bₙ are the global bases elements and c₁′, . . . , cₙ′ are the coefficients determined by neural network 610. Depth map 614 describes the distance of objects in single-view image 418. Probability distribution map 616 describes the probability of each pixel intensity value occurring in single-view image 418.

Monte Carlo integration engine 620 receives partial observation map 612, depth map 614, and probability distribution map 616 from neural network 610. First, Monte Carlo integration engine 620 generates a dense set of 3D points by sampling depth map 614. Next, Monte Carlo integration engine 620 generates coefficients 512, c′_{mc,i}, according to equation (2):

$${c}_{mc , i}^{′} \approx \frac{1}{N} {\sum }_{k = 1}^{N} \frac{{F}^{′} ( {x}_{k} ) {B}_{i} ( {x}_{k} )}{pdf ( {x}_{k} )} \qquad ( 2 )$$

where xₖ is a 3D sampling point, F′(xₖ) is the partial observation map evaluated at a 3D sampling point, Bᵢ(xₖ) is a global basis element evaluated at a 3D sampling point, and pdƒ(xₖ) is the probability density function evaluated at a 3D sampling point.

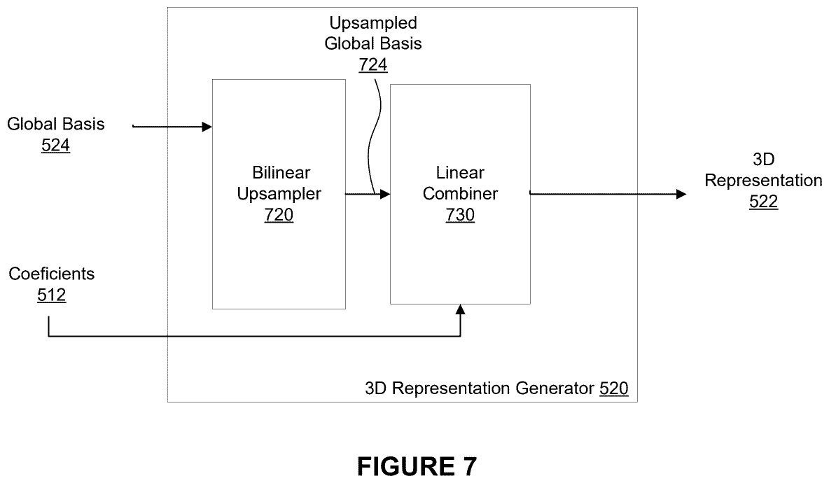

Referring back to FIG. 5, 3D representation generator 520 uses coefficients 512 and global basis 524 to generate 3D representation 522. First, 3D representation generator 520 receives of a set of global bases from global basis 524. Next, 3D representation generator 520 upsamples the set of global bases from global basis 524 so that the basis resolutions match. Then, 3D representation generator 520 generates 3D representation 522 as a linear combination of the upsampled global bases elements and the coefficients 512. The operations of 3D representation generator 520 are described in further detail below in conjunction with FIG. 7.

FIG. 7 is a more detailed illustration of 3D representation generator 520 of FIG. 5, according to various embodiments. As shown, 3D representation generator 520 includes, without limitation, bilinear upsampler 720 and linear combiner 730. Bilinear upsampler 720 receives global basis 524 and generates upsampled global basis 724. Linear combiner 730 receives upsampled global basis 724 and coefficients 512 and generates 3D representation 522.

Bilinear upsampler 720 receives global bases 524. In various embodiments, the set of global bases from global basis 524 can be a basis of triplanes, or a basis of voxels. In various embodiments, each basis in the set of global bases from global basis 524 has a different resolution. For example, a basis in the set of global bases from global basis 524 may have resolution 32×32, whereas another basis in the set of global bases from global basis 524 may have resolution 256×256. Bilinear upsampler 720 increases the resolution of the elements in the set of global bases from global basis 524 to match the element in the set of global bases from global basis 524 with the highest resolution. Bilinear upsampler 720 uses bilinear upsampling, which computes the value of new pixels by repeated linear interpolation of nearby pixels increase the resolution of the basis elements and generate upsampled global basis 724.

Linear combiner 730 receives upsampled global basis 724 and coefficients 512. Linear combiner 730 generates 3D representation 522 as a linear combination of the upsampled global bases elements of upsampled global basis 724 and coefficients 512 according to equation (3):

$$F = {c}_{1} {B}_{1} + {c}_{2} {B}_{2} + ⋯ + {c}_{n} {B}_{n} \qquad ( 3 )$$

where B₁, . . . , Bₙ are the upsampled global bases elements and c₁, . . . , cₙ are the coefficients 512. 3D representation 522 is then passed to global basis optimizer 425.

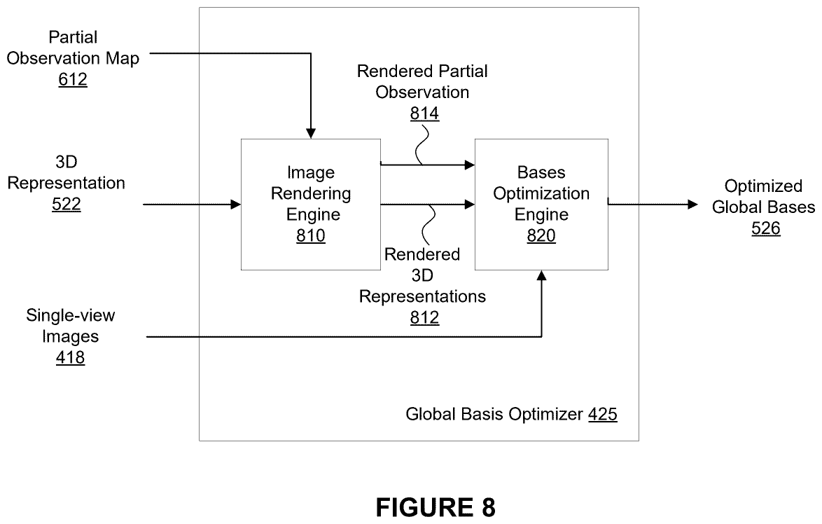

Referring back to FIG. 5, global basis optimizer 425 receives 3D representation 522 and single-view images 418. In some embodiments, where coefficients 512 are generated according to FIG. 6, global basis optimizer also receives partial observation map 612. Global basis optimizer 425 renders 3D representation 522 and determines optimized global bases 526. The operations of global basis optimizer 425 are described in further detail below in conjunction with FIG. 8.

FIG. 8 is a more detailed illustration of global basis optimizer 425 of FIG. 5, according to various embodiments. As shown, global basis optimizer 425 includes, without limitation, an image rendering engine 810 and a bases optimization engine 820. Image rendering engine 810 receives 3D representation 522 and generates rendered 3D representations 812. Bases optimization engine 820 receives rendered 3D representations 812 and single-view images 418 and generates optimized global bases 526. In some embodiments, where coefficients 512 are generated according to FIG. 6, bases optimization engine 820 also receives partial observation map 612.

Image rendering engine 810 receives 3D representation 522. Image rendering engine 810 uses 3D representation 522 to generate rendered 3D representations 812 using a volume rendering technique. Image rendering engine 810 can use any feasible volume rendering technique to generate rendered 3D representations 812, such as ray casting or shear warping. Image rendering engine 810 then passes rendered 3D representations 812 to bases optimization engine 820.

Bases optimization engine 820 receives rendered 3D representations 812, partial observation map 612, and single-view image 418. In one embodiment, where coefficients 512 are generated by a vision transformer, bases optimization engine 820 optimizes global bases elements 524 and trains the vision transformer by minimizing the batch reconstruction loss between rendered 3D representations 812 and single-view images 418. In other embodiments, where coefficients 512 are generated according to FIG. 6, bases optimization engine 820 optimizes global bases elements 524 and trains neural network 610 by jointly minimizing the batch reconstruction loss between rendered 3D representations 812 and partial observation map 612 and rendered 3D representations 812 and single-view images 418. The reconstruction loss function can include, without limitation, a combination of L₁ loss, MSE, LPIPS metric, and/or the like. Bases optimization engine 820 can use any feasible training technique, such as stochastic gradient descent with backpropagation or Adam. After training, bases optimization engine 820 generates optimized global bases 526. In various embodiments, bases optimization engine 820 generates optimized global bases 526 such that the optimized global bases 526 are orthogonal. A basis is orthogonal if the inner product of any two distinct basis elements is zero.

Referring back to FIG. 5, volume rendering engine 530 receives optimized global bases 526 and coefficients 512. First, volume rendering engine 530 generates an optimized 3D representation, F*, as a linear combination of optimized global bases 526 and coefficients 512 according to equation (4):

$$F *= {c}_{1} {B}_{1}^{*} + {c}_{2} {B}_{2}^{*} + ⋯ + {c}_{n} {B}_{n}^{*} \qquad ( 4 )$$

where c₁, . . . , cₙ are the coefficients and B₁*, . . . , Bₙ* are the optimized global bases elements. Volume rendering engine 530 then renders optimized 3D representation using a volume rendering technique. Volume rendering engine 530 can use any feasible volume rendering technique to render optimized 3D representation, such as ray casting or shear warping. The rendered optimized 3D representation is a rendered reconstructed 3D scene 422 that closely matches single-view images 418.

### Generating Optimized Global Bases

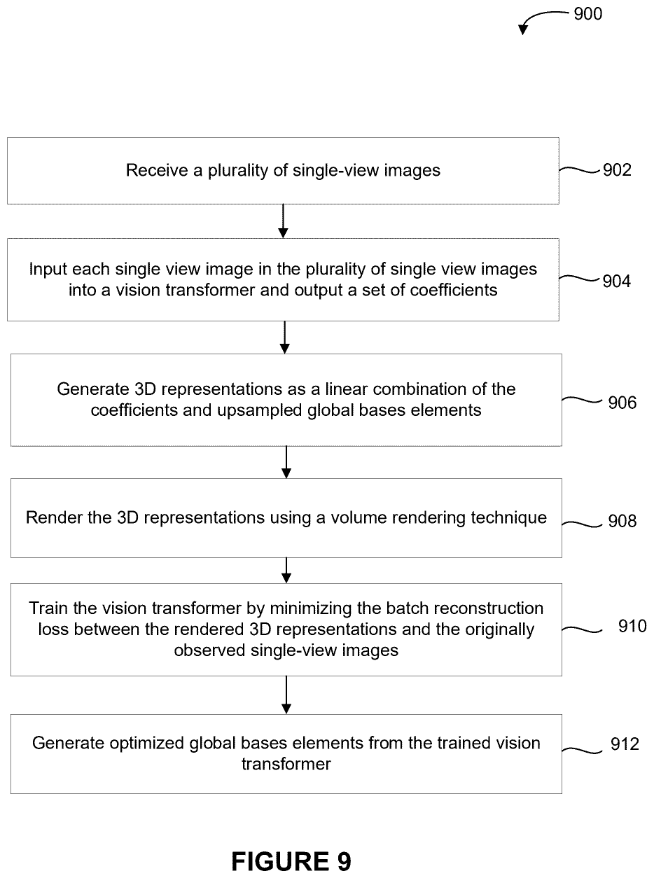

FIG. 9 is a flow diagram of method steps for generating optimized global bases, according to various embodiments. Although the method steps are described in conjunction with the embodiments of FIGS. 1-8, persons skilled in the art will understand that any system configured to perform the method steps, in any order, falls within the scope of the various embodiments.

As shown, a method 900 begins at step 902, where 3D scene reconstruction engine 416 receives a plurality of single-view images 418. A single-view image 418 is a single image obtained from one viewpoint of a scene. Single-view images 418 can be obtained by any type of technically feasible camera or video capture device such as camera(s) 435. For example, and without limitation, single-view images 418 can be obtained by a monocular camera such as a smartphone camera or a camera located in a vehicle.

At step 904, each single-view image 418 is input into a vision transformer and

the vision transformer outputs a set of coefficients. More specifically, each single-view image 418 is input into coefficient generator 510. Upon receiving single-view images 418, coefficient generator 510 passes single-view images 418 through multiple transformer blocks. After passing single-view images 418 through the transformer blocks of coefficient generator 510, coefficient generator 510 generates coefficients 512.

At step 906, 3D representation generator 520 generates a 3D representation 522 as a linear combination of the coefficients 512 and upsampled global bases elements. More specifically, 3D representation generator 520 first increases the resolution of the elements in the set of global bases from global basis 524 to match the element in the set of global bases from global basis 524 with the highest resolution using a bilinear upsampling technique. 3D representation generator 520 then generates 3D representation 522 as a linear combination of the upsampled global bases elements of upsampled global basis 724 and coefficients 512 according to equation (3).

At step 908, image rendering engine 810 renders the 3D representation 522 using a volume rendering technique. Image rendering engine 810 can use any feasible volume rendering technique to render the 3D representation 522 and generate rendered 3D representations 812, such as ray casting or shear warping.

At step 910, bases optimization engine 820 generates optimized global bases elements 526 by minimizing the batch reconstruction loss between rendered 3D representations 812 and single-view images 418. The reconstruction loss function can include, without limitation, a combination of L₁ loss, MSE, LPIPS metric, and/or the like. Bases optimization engine 820 can use any feasible training technique, such as stochastic gradient descent with backpropagation or Adam.

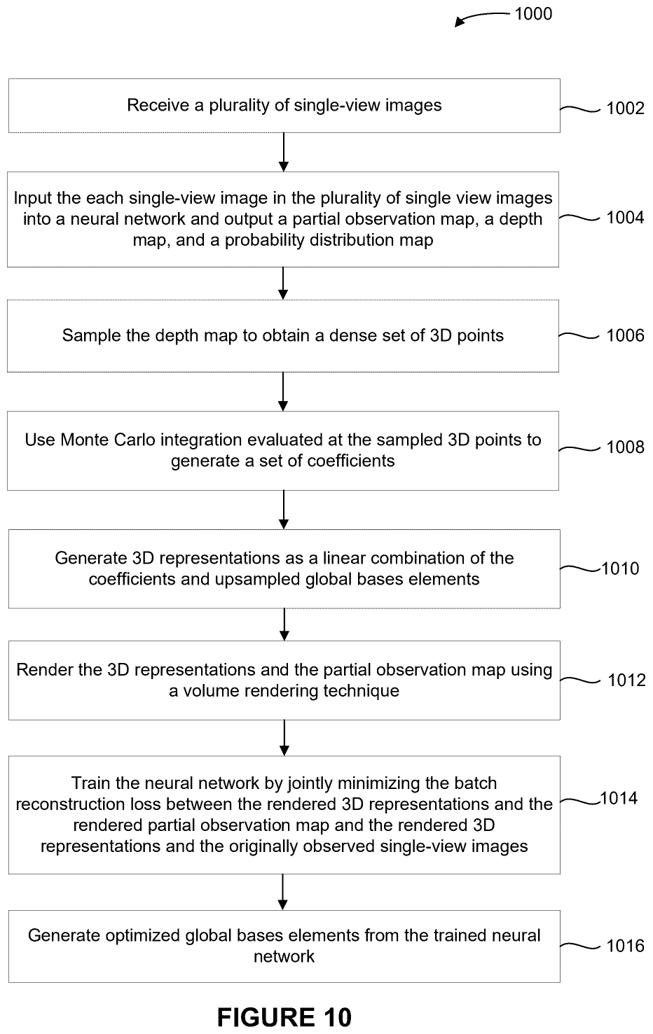

FIG. 10 is a flow diagram of method steps for generating optimized global bases, according to various embodiments. Although the method steps are described in conjunction with the embodiments of FIGS. 1-8, persons skilled in the art will understand that any system configured to perform the method steps, in any order, falls within the scope of the various embodiments.

As shown, a method 1000 begins at step 1002, where 3D scene reconstruction engine 416 receives a plurality of single-view images 418. A single-view image 418 is a single image obtained from one viewpoint of a scene. Single-view images 418 can be obtained by any type of technically feasible camera or video capture device such as camera(s) 435. For example, and without limitation, single-view images 418 can be obtained by a monocular camera such as a smartphone camera or a camera located in a vehicle.

At step 1004, each single-view image 418 is input into a neural network 610 and neural network 610 outputs a partial observation map 612, a depth map 614, and a probability distribution map 616. Upon receiving single-view images 418, neural network 610 passes single-view images 418 through multiple layers. After passing initial single-view images 418 through the layers of neural network 610, neural network 610 generates a partial observation map 612, a depth map 614, and a probability distribution map 616. Partial observation map 612 is a linear combination of global bases elements of global basis 524 and coefficients determined by neural network 610 according to equation (1). Depth map 614 describes the distance of objects in single-view image 418. Probability distribution map 616 describes the probability of each pixel intensity value occurring in single-view image 418.

At step 1006, Monte Carlo integration engine 620 samples the depth map 614 to obtain a dense set of 3D points. More specifically, Monte Carlo integration engine 620 generates a dense set of 3D points by sampling depth map 614.

At step 1008, Monte Carlo integration engine 620 uses Monte Carlo integration evaluated at the sampled 3D points to generate a set of coefficients 512. More specifically, Monte Carlo integration engine 620 uses probability distribution map 616 and partial observation map 612 evaluated at the 3D sampling points to generate coefficients according to equation (2).

At step 1010, 3D representation generator 520 generates a 3D representation 522 as a linear combination of the coefficients 512 and upsampled global bases elements. More specifically, 3D representation generator 520 first increases the resolution of the elements in the set of global bases from global basis 524 to match the element in the set of global bases from global basis 524 with the highest resolution using a bilinear upsampling technique. 3D representation generator 520 then generates 3D representation 522 as a linear combination of the upsampled global bases elements of upsampled global basis 724 and coefficients 512 according to equation (3).

At step 1012, image rendering engine 810 renders the 3D representation 522 using a volume rendering technique. Image rendering engine 810 can use any feasible volume rendering technique to render the 3D representation 522 and generate rendered 3D representations 812, such as ray casting or shear warping.

At step 1014, bases optimization engine 820 generate optimized global bases elements 526 by jointly minimizing the batch reconstruction loss between rendered 3D representations 812 and the partial observation map 612 and the rendered 3D representations 812 and the single-view images 418. The reconstruction loss function can include, without limitation, a combination of L₁ loss, MSE, LPIPS metric, and/or the like. Bases optimization engine 820 can use any feasible training technique, such as stochastic gradient descent with backpropagation or Adam.

### Generating Reconstructed 3D Scenes

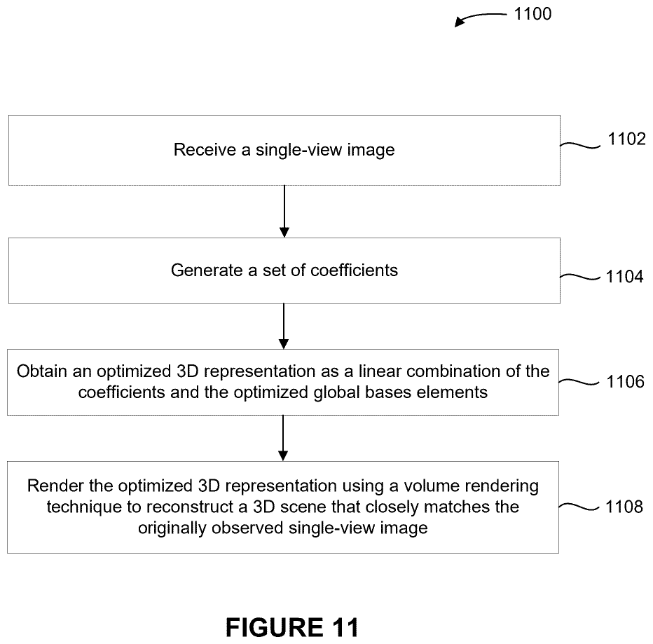

FIG. 11 is a flow diagram of method steps for generating a reconstructed 3D scene, according to various embodiments. Although the method steps are described in conjunction with the embodiments of FIGS. 1-8, persons skilled in the art will understand that any system configured to perform the method steps, in any order, falls within the scope of the various embodiments.

As shown, a method 1100 begins at step 1002, where 3D scene reconstruction engine 416 receives a single-view image 418. Single-view image 418 is a single image obtained from one viewpoint of a scene. Single-view image 418 can be obtained by any type of technically feasible camera or video capture device such as camera(s) 435. For example, and without limitation, single-view image 418 can be obtained by a monocular camera such as a smartphone camera or a camera located in a vehicle.

At step 1104, coefficient generator 510 generates a set of coefficients 512. In various embodiments coefficient generator 510 generates a set of coefficients 512 using a vision transformer. In other embodiments, coefficient generator 510 generates a set of coefficients 512 using a neural network 610 and Monte Carlo integration. global basis 524 chooses a set of global bases and generates an initial 3D representation that is a linear combination of the global bases elements and initial coefficients.

At step 1106, 3D scene reconstruction engine 416 obtains an optimized 3D representation as a linear combination of the coefficients 512 and the optimized global basis 526. More specifically, volume rendering engine 530 generates an optimized 3D representation as a linear combination of optimized global bases 526 and coefficients 512 according to equation (4).

At step 1108, volume rendering engine 530 renders the optimized 3D representation using a volume rendering technique to render a reconstructed 3D scene that closely matches the originally observed single-view image 418. Volume rendering engine 530 can use any feasible volume rendering technique to render optimized 3D representation, such as ray casting or shear warping.

In sum, a 3D reconstruction of a 3D scene is generated using a single-view image. First, a set of global bases, such as triplanes or voxels is chosen. Then a set of coefficients is generated 1) using a vision transformer, or 2) by using a neural network and Monte Carlo integration. When using the vision transformer, a single-view image is input into a vision transformer and the output of the vision transformer is a set of coefficients. Then a 3D representation is obtained as a linear combination of the coefficients and the upsampled global bases elements. The 3D representation is rendered using a volume rendering technique. The global bases elements are optimized, and the vision transformer is trained by minimizing the batch reconstruction loss between the rendered 3D representations and the originally observed single-view images. When using the neural network and Monte Carlo integration, the neural network generates a partial observation map, a depth map, and a probability distribution map. Next, a dense set of 3D points is obtained by sampling the depth map. Then, coefficients are generated using Monte Carlo integration evaluated at the sampled 3D points. A 3D representation is generated as a linear combination of the coefficients and the upsampled global bases elements. The 3D representation is rendered using a volume rendering technique. The global bases elements are optimized, and the neural network is trained by jointly minimizing the batch reconstruction loss between the 3D representations and the partial observation map and the rendered 3D representation and the originally observed single view images. Whether generated by either method, an optimized 3D representation is obtained as a linear combination of the coefficients and the optimized global bases elements. The optimized 3D representation is then rendered using a volume rendering technique to reconstruct a 3D scene that closely matches the originally observed single-view image.

At least one technical advantage of the disclosed techniques relative to the prior art is that, with the disclosed techniques, accurate reconstruction of 3D scenes can be generated from a single-view image. The disclosed technique can generate accurate reconstruction of 3D scenes that are consistent across multiple views and yields consistent 3D shapes from one single-view image, eliminating the need for large labeled multi-view datasets to generate the reconstructed 3D scene. In addition, with the disclosed techniques accurate reconstruction of 3D scenes can be generated without having to train specialized neural models, which significantly reduces the computing resources used to generate the reconstructed 3D scene. These technical advantages represent one or more technological improvements over prior art approaches.

Aspects of the subject matter described herein are set out in the following numbered clauses.

1. In some embodiments, a computer-implemented method for reconstructing 3D scenes comprises receiving a single-view image, generating a plurality of coefficients, generating an optimized 3D representation from a plurality of optimized basis elements and the plurality of coefficients, rendering the optimized 3D representation to generate a volume rendering, and reconstructing a 3D scene from the volume rendering.

2. The computer-implemented method of clause 1, wherein the single-view image is a 2D image.

3. The computer-implemented method of clauses 1 or 2, wherein the plurality of optimized basis elements are voxels or triplanes.

4. The computer-implemented method of any of clauses 1-3, wherein generating the optimized 3D representation comprises generating a linear combination of the plurality of optimized basis elements using the plurality of coefficients.

5. The computer-implemented method of any of clauses 1-4, wherein generating the volume rendering comprises ray casting or shear warping.

6. The computer-implemented method of any of clauses 1-5, wherein generating the plurality of coefficients comprises using a machine learning model.

7. The computer-implemented method of any of clauses 1-6, wherein the machine learning model comprises a vision transformer.

8. The computer-implemented method of any of clauses 1-7, wherein generating the plurality of coefficients comprises processing the single-view image using a machine learning model to generate a partial observation map, a depth map, and a probability distribution map, sampling the depth map to generate a dense set of 3D points, and performing Monte Carlo integration on 3D points in the dense set of 3D points based on the probability distribution map to generate a plurality of coefficients.

9. The computer-implemented method of any of clauses 1-8, wherein the machine learning model comprises a U-Net model or a convolutional network.

10. The computer-implemented method of any of clauses 1-9, wherein generating the plurality of optimized bases elements comprises generating a 3D representation from a plurality of basis elements and the plurality of coefficients, rendering the 3D representation to generate a plurality of volume renderings, and minimizing a batch reconstruction loss between the plurality of volume renderings and a plurality of single-view images to generate the plurality of optimized bases elements.

11. The computer-implemented method of any of clauses 1-10, wherein the batch reconstruction loss comprises one or more of an L1 loss, a mean squared error, or an LPIPS metric.

12. The computer-implemented method of any of clauses 1-11, wherein generating the plurality of optimized bases elements comprises generating a 3D representation from a plurality of basis elements and the plurality of coefficients, rendering the 3D representation to generate a plurality of volume renderings, and minimizing a batch reconstruction loss between the plurality of volume renderings and a partial observation map and the plurality of volume renderings and a plurality of single-view images to generate the plurality of optimized bases elements.

13. The computer-implemented method of any of clauses 1-12, wherein the batch reconstruction loss comprises one or more of an L1 loss, a mean squared error, or an LPIPS metric.

14. In some embodiments, one or more non-transitory computer-readable media store instructions that, when executed by at least one processor, cause the at least one processor to perform the steps of receiving a single-view image, generating a plurality of coefficients, generating an optimized 3D representation from a plurality of optimized basis elements and the plurality of coefficients, rendering the optimized 3D representation to generate a volume rendering, and reconstructing a 3D scene from the volume rendering.

15. The one or more non-transitory computer-readable media of clause 14, wherein generating the optimized 3D representation comprises generating a linear combination of the plurality of optimized basis elements using the plurality of coefficients.

16. The one or more non-transitory computer-readable media of clauses 14 or 15, wherein generating the plurality of coefficients comprises using a machine learning model.

17. The one or more non-transitory computer-readable media of any of clauses 14-16, wherein generating the plurality of coefficients comprises processing the single-view image using a machine learning model to generate a partial observation map, a depth map, and a probability distribution map, sampling the depth map to generate a dense set of 3D points, and performing Monte Carlo integration on 3D points in the dense set of 3D points based on the probability distribution map to generate a plurality of coefficients.

18. The one or more non-transitory computer-readable media of any of clauses 14-17, wherein generating the plurality of optimized bases elements comprises generating a 3D representation from a plurality of basis elements and the plurality of coefficients, rendering the 3D representation to generate a plurality of volume renderings, and minimizing a batch reconstruction loss between the plurality of volume renderings and a plurality of single-view images to generate the plurality of optimized bases elements.

19. The one or more non-transitory computer-readable media of any of clauses 14-18, wherein generating the plurality of optimized bases elements comprises generating a 3D representation from a plurality of basis elements and the plurality of coefficients, rendering the 3D representation to generate a plurality of volume renderings, minimizing a batch reconstruction loss between the plurality of volume renderings and a partial observation map and the plurality of volume renderings and a plurality of single-view images to generate the plurality of optimized bases elements.

20. In some embodiments, a system comprises one or more memories storing instructions, and one or more processors that are coupled to the one or more memories and, when executing the instructions, are configured to perform steps comprising receiving a single-view image, generating a plurality of coefficients, generating an optimized 3D representation from a plurality of optimized basis elements and the plurality of coefficients, rendering the optimized 3D representation to generate a volume rendering, and reconstructing a 3D scene from the volume rendering.

Any and all combinations of any of the claim elements recited in any of the claims and/or any elements described in this application, in any fashion, fall within the contemplated scope of the present disclosure and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for reconstructing 3D scenes, the method comprising:
receiving a single-view image;
generating a plurality of coefficients;
generating an optimized 3D representation from a plurality of optimized basis elements and the plurality of coefficients;
rendering the optimized 3D representation to generate a volume rendering; and
reconstructing a 3D scene from the volume rendering.

2. The computer-implemented method of claim 1, wherein the single-view image is a 2D image.

3. The computer-implemented method of claim 1, wherein the plurality of optimized basis elements are voxels or triplanes.

4. The computer-implemented method of claim 1, wherein generating the optimized 3D representation comprises generating a linear combination of the plurality of optimized basis elements using the plurality of coefficients.

5. The computer-implemented method of claim 1, wherein generating the volume rendering comprises ray casting or shear warping.

6. The computer-implemented method of claim 1, wherein generating the plurality of coefficients comprises using a machine learning model.

7. The computer-implemented method of claim 6, wherein the machine learning model comprises a vision transformer.

8. The computer-implemented method of claim 1, wherein generating the plurality of coefficients comprises:
processing the single-view image using a machine learning model to
generate a partial observation map, a depth map, and a probability distribution map;
sampling the depth map to generate a dense set of 3D points; and
performing Monte Carlo integration on 3D points in the dense set of 3D points based on the probability distribution map to generate a plurality of coefficients.

9. The computer-implemented method of claim 8, wherein the machine learning model comprises a U-Net model or a convolutional network.

10. The computer-implemented method of claim 1, wherein generating the plurality of optimized bases elements comprises:
generating a 3D representation from a plurality of basis elements and the plurality of coefficients;
rendering the 3D representation to generate a plurality of volume renderings; and
minimizing a batch reconstruction loss between the plurality of volume renderings and a plurality of single-view images to generate the plurality of optimized bases elements.

11. The computer-implemented method of claim 10, wherein the batch reconstruction loss comprises one or more of an L1 loss, a mean squared error, or an LPIPS metric.

12. The computer-implemented method of claim 1, wherein generating the plurality of optimized bases elements comprises:
generating a 3D representation from a plurality of basis elements and the plurality of coefficients;
rendering the 3D representation to generate a plurality of volume renderings; and
minimizing a batch reconstruction loss between the plurality of volume renderings and a partial observation map and the plurality of volume renderings and a plurality of single-view images to generate the plurality of optimized bases elements.

13. The computer-implemented method of claim 12, wherein the batch reconstruction loss comprises one or more of an L1 loss, a mean squared error, or an LPIPS metric.

14. One or more non-transitory computer-readable media storing instructions that, when executed by at least one processor, cause the at least one processor to perform the steps of:
receiving a single-view image;
generating a plurality of coefficients;
generating an optimized 3D representation from a plurality of optimized basis elements and the plurality of coefficients;
rendering the optimized 3D representation to generate a volume rendering; and
reconstructing a 3D scene from the volume rendering.

15. The one or more non-transitory computer-readable media of claim 14, wherein generating the optimized 3D representation comprises generating a linear combination of the plurality of optimized basis elements using the plurality of coefficients.

16. The one or more non-transitory computer-readable media of claim 14, wherein generating the plurality of coefficients comprises using a machine learning model.

17. The one or more non-transitory computer-readable media of claim 14, wherein generating the plurality of coefficients comprises:
processing the single-view image using a machine learning model to
generate a partial observation map, a depth map, and a probability distribution map;
sampling the depth map to generate a dense set of 3D points; and
performing Monte Carlo integration on 3D points in the dense set of 3D points based on the probability distribution map to generate a plurality of coefficients.

18. The one or more non-transitory computer-readable media of claim 14, wherein generating the plurality of optimized bases elements comprises:
generating a 3D representation from a plurality of basis elements and the plurality of coefficients;
rendering the 3D representation to generate a plurality of volume renderings; and
minimizing a batch reconstruction loss between the plurality of volume renderings and a plurality of single-view images to generate the plurality of optimized bases elements.

19. The one or more non-transitory computer-readable media of claim 14, wherein generating the plurality of optimized bases elements comprises:
generating a 3D representation from a plurality of basis elements and the plurality of coefficients;
rendering the 3D representation to generate a plurality of volume renderings;
minimizing a batch reconstruction loss between the plurality of volume renderings and a partial observation map and the plurality of volume renderings and a plurality of single-view images to generate the plurality of optimized bases elements.

20. A system, comprising:
one or more memories storing instructions; and
one or more processors that are coupled to the one or more memories and, when executing the instructions, are configured to perform steps comprising:
receiving a single-view image;
generating a plurality of coefficients;
generating an optimized 3D representation from a plurality of optimized basis elements and the plurality of coefficients;
rendering the optimized 3D representation to generate a volume rendering; and
reconstructing a 3D scene from the volume rendering.
